(19) United States
(12) Patent Application Publication
(10) Pub. No.: US 2026/0327904 A1
(43) Pub. Date: Oct. 22, 2026

(54) PLANT CONTAINER COMPOSITION

(71) Applicant: PLANTOPIA ECO PULP LTD, Manchester (GB)

(72) Inventor: Christopher Partington HALEY, Lancashire (GB)

(21) Appl. No.: 19/106,712

(22) PCT Filed: Aug. 29, 2023
(86) PCT No.: PCT/GB2023/052224

§ 371 Date: Feb. 26, 2025

(30) Foreign Application Priority Data
Aug. 31, 2022 (GB) 2212662.7

(51) Int. Cl. D21H 17/68; A01G 9/02; A01G 9/029; D21H 11/12; D21J 5/00

(52) U.S. Cl. CPC D21H 17/68; A01G 9/021; A01G 9/0291; D21H 11/12; D21J 5/00

(57) ABSTRACT

A material composition for use in a pulp moulding process to form plant containers or seed trays includes at least one biodegradable fibrous material such as cotton grass root fibres, at least one aggregate formed of a lightweight, natural, inorganic, and absorbent material such as a lightweight expanded clay aggregate, and a biodegradable binding agent or glue. A method of forming a plant pot uses pulp moulding machinery.

The present invention relates to pulp formed containers, for containing and transporting plants or seeds. Certain embodiments of the present invention relate to a plant containers such as plant pots, or cell trays, having a particular composition, and to a method of manufacturing such a plant container or cell tray.

In the horticulture industry, plant pots commonly formed of pulp material. The pulp material is moulded to form a semi rigid, water and air permeable membrane, which allows an unimpeded passage of plant roots. A plant can be transplanted in the pot, i.e. the plant does not need to be removed from the pot. After transplantation, the pulp material of the pot disintegrates into the soil.

It is commonly accepted that pulp formed plant pots should be formed of only of materials which are a benefit to the ground, or to the growing medium to be used in the plant pot. Known materials for pulp formed plant pots/cell trays include wastepaper and cardboard; these materials are also used in other pulp forming applications such as egg trays and cartons, and general industrial packaging. However, the compatibility of wastepaper and cardboard as a growing medium is in question.

Other materials commonly used in pulp forming include bagasse, coir and, indeed, any commercially available natural fibres. Fibrous peat was also previously used to form pulp plant pots; this is now being replaced with a mixed fibre mixture with a lower peat content, as peat extraction is no longer encouraged for environmental reasons, and may eventually be entirely phased out.

Currently known pulp plant pots may also display poor structural integrity of the membrane, affecting the longevity of the membrane. Furthermore, currently known pots suffer from disadvantages in product design for compatibility with modern industrial handling machinery. It is an aim of the present invention to provide an improved pulp material for forming plant pots or cell trays.

In a first aspect, the present invention comprises a composition for use in a pulp moulding process, comprising at least one biodegradable fibrous material, at least one aggregate formed of a lightweight, natural, inorganic, and absorbent material, and a biodegradable binding agent.

The at least one fibrous material may comprise at least one of cotton grass root fibres, wastepaper fibres, and cardboard fibres.

The at least one aggregate may comprise at least one of lightweight expanded clay aggregate, terracotta, perlite, vermiculite, and pumice.

The at least one fibrous material comprise may cotton grass root fibres, and wastepaper or cardboard fibres, and the aggregate comprises lightweight expanded clay aggregate.

The composition may comprise an equal proportion by weight of the cotton grass root fibres, the wastepaper or cardboard fibres, and the aggregate.

In a further aspect the present invention comprises a method of mould forming a plant container, the method comprising steps of;
a) mixing together at least one biodegradable fibrous material, at least one aggregate formed of a lightweight, natural, inorganic, and absorbent material, and a biodegradable binding agent, to form a mixture;
b) pulping the mixture to form a pulp;
c) dipping at least one platen comprising a plurality of moulds into the pulp;
d) vacuuming the pulp into the plurality of moulds, to form a plurality of wet moulded plant containers;
e) drying the plurality of wet moulded plant containers, to form a plurality of formed plant containers; and
f) removing formed plant containers from the moulds.

Drying the formed plant containers comprises passing the plant containers through a drying tunnel or air drying the plant containers.

The fibrous material may be a cotton grass root fibre, and the method may comprise a preceding step of obtaining the cotton grass root fibre as a by-product of a peat extraction process, or by natural harvesting.

The method may further comprising a step of, prior to step mixing, sieving and/or grading particles of the aggregate.

In a further aspect, the present invention comprises a plant container formed by a method as described above.

Embodiments of the present invention will now be described hereinafter, by way of example only, with reference to the accompanying drawings in which:

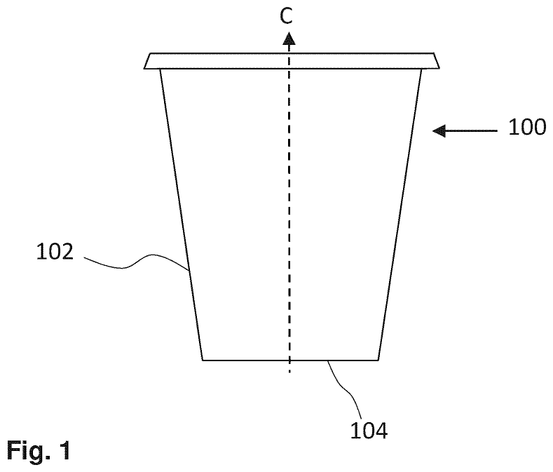

FIG. 1 is a front view of a plant pot in accordance with the present invention;

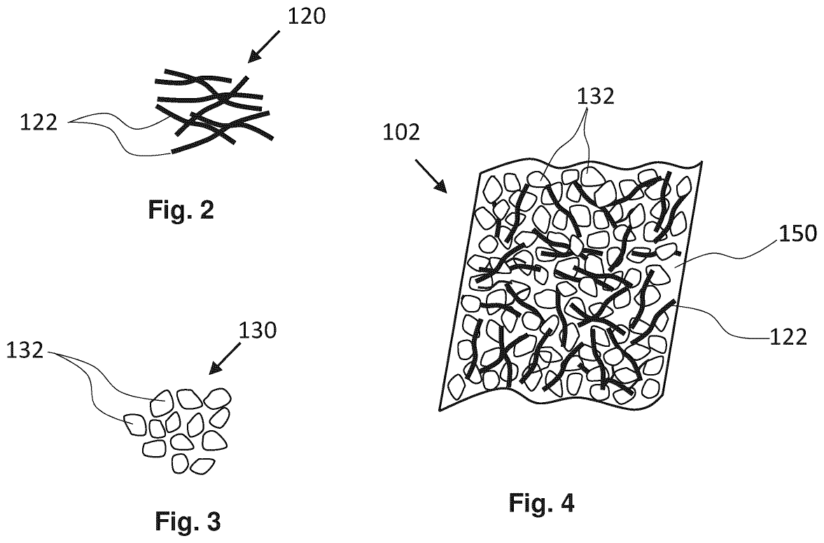

FIG. 2 is a schematic representation of a fibrous material of a composition in accordance with the present invention;

FIG. 3 is a schematic representation of an aggregate of a composition in accordance with the present invention;

FIG. 4 is a schematic cross-sectional view through a wall of the plant pot of FIG. 1;

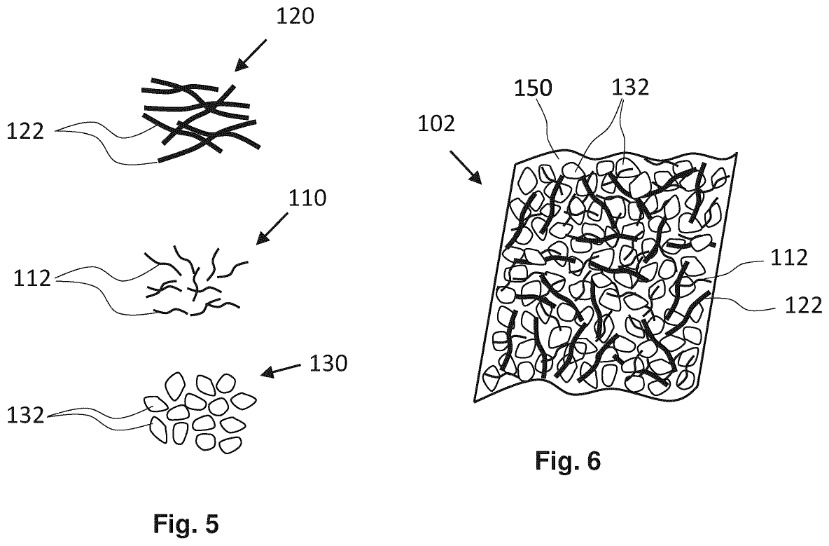

FIG. 5 is a schematic representation of a first fibrous material, a second fibrous material and an aggregate of a composition in accordance with an alternative embodiment of the present invention; and

FIG. 6 is a schematic cross-sectional view through a wall of the plant pot formed of the alternative composition of FIG. 4.

In the drawings, like reference numerals refer to like parts.

The present invention comprises a composition for moulding a plant container such as a pot, i.e. a material composition which is suitable for using in a mould forming process to produce a plant container. The material composition of the present invention may also be used to mould form other types of containers or horticultural products such as cell trays.

Referring to FIG. 1, an example plant container comprises a plant pot 100, comprising a substantially frustoconical shape formed of a single wall 102 formed at a known angle to a central vertical axis C, and a base 104, which is integral to the wall 102.

The plant pot 100 is formed of a material composition comprising three materials; a biodegradable fibrous material, a lightweight, natural inorganic aggregate, and a biodegradable binding agent. The material composition is mould formed into a plant pot 100 using a vacuum process.

The fibrous material in the present example is cotton grass root fibres 120 (FIG. 2), i.e. the roots of a cotton grass plant, (also known as cotton sedge fibres). Cotton grass root may be obtained as a by-product of a peat extraction as it is cleared from the upper levels of the ground to reach the peat levels. Alternatively, cotton grass can been independently harvested in a sustainable matter, therefore it could still be obtained even if peat extraction were to cease. The cotton grass root 120 consists of organic biodegradable long fibres 122, which provide a plant pot, once formed, with an acceptable strength, durability and longevity.

The aggregate material is lightweight, natural, inorganic, and absorbent. The lightweight, natural inorganic aggregate in the present invention is an inorganic lightweight aggregate (LWA), specifically a L.E.C. A (Lightweight Expanded Clay Aggregate) 130 (FIG. 3). L.E.C. A 130 is formed of a mix of small particles 132; all particles could be, for example, an average of 2 mm in or less. L.E.C.A. has many advantages, including the ability to absorb water along with nutrient without shrinkage.

In an alternative embodiment, the aggregate could comprise terracotta, for example waste produced as by-product from a terracotta factory. Further examples of aggregate which could be used are perlite, vermiculite, pumice, or any other aggregate formed of a lightweight, natural, inorganic material which absorbs water, and does not exhibit shrinkage. Furthermore, a combination of suitable materials could be used.

The fibrous material is relatively open, i.e. with gaps between the fibres. When mixed with the aggregate, the particles of the aggregate partially fill in the gaps between fibres of the fibrous material.

FIG. 4 shows a cross-section through a wall 102 of a plant pot formed of a composition according to the present invention. The binding agent is present in the space 150 surrounding the fibrous material 120 and the aggregate material 130.

In an example embodiment, the composition is formed of approximately equal proportions of the fibrous material and of the aggregate.

A further example of the present invention is illustrated FIGS. 5 and 6, and comprises a first fibrous material 120, a second fibrous material 110 and an aggregate 130. The first fibrous material 120 could be a material comprising relatively long fibres, such as cotton grass root fibres 122, and the second fibrous material 110 could be a material comprising relatively shorter fibres 112, such as wastepaper or cardboard. The composition could comprise equal proportions of the first fibrous material 120, the second fibrous material 110, and the aggregate 130. FIG. 6 shows a cross-sectional view through a wall of the plant pot formed of the alternative composition, with binding agent present in the space 150 between the first and second fibrous materials 120, 110 and the aggregate 130.

The binding agent in the present invention is a biodegradable glue which binds together the cotton grass root and the L.E.C.A. The proportion of the glue in the composition can be selected to provide an predetermined time period for bio-degradation. Once the glue has biodegraded, the binding between the leaving the cotton grass root and L.E.C. A is released. The separated cotton grass root and L.E.C.A. provide natural soil enhancers, i.e. they are of benefit to the ground and to the growing medium used in the plant pot.

It would not be possible to use fibrous material alone to mould form a plant pot, as it is too open and porous to utilize the vacuum in the mould forming process; i.e. it would not be possible to obtain a sufficient vacuum to form a plant pot. The aggregate would also not be viable for the moulding process on its own. However, a combination of at least one fibrous material, the aggregate and the binding agent, facilitates a more efficient mould forming than prior art compositions such as conventional paper pulp. The addition of an inorganic aggregate to the material composition in the present invention acts as a physical catalyst in the mould forming process.

The composition of the present invention can be used in a conventional mould forming machine, such as a full rotary moulder, or a reciprocating moulder, having a single or multiple platens.

As example method of manufacture of a plant receptacle or container, such as a pot, comprises steps of mixing together the at least one biodegradable fibrous material, the at least one aggregate formed of a lightweight, natural, inorganic, and absorbent material, and a the biodegradable binding agent, to form a mixture. The mixture is then pulped. At least one platen, comprising a plurality of moulds, is then dipped into the pulp, and the pulp is then vacuumed into the plurality of moulds, to form a plurality of wet moulded plant containers. The wet moulded plant containers are then dried, for example by being passed through a drying tunnel, or by allowing to air dry. A plurality of dry, formed plant containers are removed from the moulds.

As described above, the raw aggregate may comprise particles within a range of sizes, for example a mixture of particle sizes up to 2 mm. Optionally, before the ingredients of the composition are mixed together, the aggregate can be sieved and/or graded, to separate aggregate particles of a particular size, or within a particular size range. This method step enables the use of aggregate particles of a predetermined size, or within a predetermined size range, to be used in the composition. Relatively smaller particles can be used if a relatively more dense/closed composition is required, whereas for a more relatively less dense/more open composition is required, relatively larger particles can be used.

The material composition of the present invention is compatible with conventional pulp forming machinery.

Furthermore, the composition of the present invention results in an superior growth medium, i.e. natural soil enhancer, compared to prior art compositions.

The illustrated embodiments are not limiting. The material composition of the present invention is of particular use in the horticultural industry for transplantable plant containers, however it could be used to form any containers or other product formed by a pulp moulding process.

1. A composition for use in a pulp moulding process, comprising at least one biodegradable fibrous material, at least one aggregate formed of a lightweight, natural, inorganic, and absorbent material, and a biodegradable binding agent.

2. A composition as claimed in claim 1 wherein the at least one fibrous material comprises at least one of cotton grass root fibres, wastepaper fibres, and cardboard fibres.

3. A composition as claimed in claim 1 wherein the at least one aggregate comprises at least one of lightweight expanded clay aggregate, terracotta, perlite, vermiculite, and pumice.

4. A composition as claimed in claim 1 wherein the at least one fibrous material comprises cotton grass root fibres, and wastepaper or cardboard fibres, and the aggregate comprises lightweight expanded clay aggregate.

5. A composition as claimed in claim 4 comprising an equal proportion by weight of the cotton grass root fibres, the wastepaper or cardboard fibres, and the aggregate.

6. A method of mould forming a plant container, the method comprising steps of;
a) mixing together at least one biodegradable fibrous material, at least one aggregate formed of a lightweight, natural, inorganic, and absorbent material, and a biodegradable binding agent, to form a mixture;
b) pulping the mixture to form a pulp;
c) dipping at least one platen comprising a plurality of moulds into the pulp;
d) vacuuming the pulp into the plurality of moulds, to form a plurality of wet moulded plant containers;
e) drying the plurality of wet moulded plant containers, to form a plurality of formed plant containers; and
f) removing formed plant containers from the moulds.

7. A method as claimed in claim 6 wherein drying the plurality of wet moulded plant containers comprises passing the plant containers through a drying tunnel or air drying the plant containers.

8. A method as claimed in claim 6 wherein the fibrous material is a cotton grass root fibre, and wherein the method comprises a preceding step of obtaining the cotton grass root fibre as a by-product of a peat extraction process, or by natural harvesting.

9. A method as claimed in claim 6 further comprising a step of, prior to step mixing, sieving and/or grading particles of the aggregate.

10. A plant container formed by a method as claimed in claim 6.
